(19) United States
(12) Patent Application Publication
(10) Pub. No.: US 2025/0117927 A1
(43) Pub. Date: Apr. 10, 2025

(54) METHOD AND APPARATUS FOR MEASURING FAT CONTENT USING CT IMAGE

(71) Applicant: MEDICALIP CO., LTD., Gangwon-do (KR)

(72) Inventors: Sang Joon PARK, Seoul (KR); Jong Min KIM, Gyeonggi-do (KR); Han Jae CHUNG, Seoul (KR)

(73) Assignee: MEDICALIP CO., LTD., Gangwon-do (KR)

(21) Appl. No.: 18/484,412

(22) Filed: Oct. 10, 2023

(51) Int. Cl. G06T 7/00

(52) U.S. Cl. CPC G06T 7/0012; G06T 2207/10081; G06T 2207/20081; G06T 2207/30004

(57) ABSTRACT

Provided is a method and apparatus for measuring fat content using a computed tomography (CT) image. The fat content measurement apparatus trains a fat prediction model by using learning data including a CT image or noise image for learning and generates a fat distribution image to be used for fat content measurement by the fat prediction model having completed learning upon receiving a CT image for diagnosis.

### BACKGROUND

### 1. Field

The disclosure relates to a method and apparatus for measuring fat content by using a computed tomography (CT) image.

### 2. Description of the Related Art

There are various methods to measure fat content, such as a method using ultrasonic waves, a method using impedance obtained by applying a microcurrent, etc. In the method using ultrasonic waves, a medical staff checks fat content through ultrasonography, and method has a limitation in representing the fat content of a particular tissue (e.g., a liver, etc.) by an exact numerical value. In the method using impedance to measure fat content, the overall fat content may be quantified, but it is difficult to accurately determine the fat content of a particular region of a body such as a liver, etc.

As a method of accurately quantifying the fat content of a human liver, etc., there is a method of calculating a proton distribution fat fraction (PDFF) by using a magnetic resonance image (MRI). In the PDFF method, a distribution of a quantum density of fat in an MRI is measured. However, the PDFF method may not be applied to a CT image.

### SUMMARY

Provided is a method and apparatus for measuring fat content by using a computed tomography (CT) image.

Additional aspects will be set forth in part in the description which follows and, in part, will be apparent from the description, or may be learned by practice of the presented embodiments.

According to an aspect of the disclosure, a fat content measurement method performed by a fat content measurement apparatus includes receiving learning data including a computed tomography (CT) image or noise image for learning, training, by using the learning data, a fat prediction model configured to generate a fat distribution image for a CT image, and generating a fat distribution image to be used for fat content measurement by the fat prediction model having completed learning upon receiving a CT image for diagnosis, in which the training includes training a fat prediction model such that a loss function indicating an error between a converted image, obtained by applying a predefined conversion equation to the CT image or noise image for learning, and the fat distribution image output by the fat prediction model is minimum.

According to another aspect of the disclosure, a fat content measurement apparatus includes an input unit configured to input a computed tomography (CT) image for diagnosis to a fat prediction model trained using learning data including a CT image or noise image for learning and a fat image generation unit configured to generate and output a fat distribution image for the CT image for diagnosis through the fat prediction model.

### BRIEF DESCRIPTION OF THE DRAWINGS

The above and other aspects, features, and advantages of certain embodiments will be more apparent from the following description taken in conjunction with the accompanying drawings, in which:

FIG. 1 is a view showing an example of a fat content measurement apparatus according to an embodiment;

FIG. 2 is a view showing an example of a method of obtaining a proton distribution fat fraction (PDFF) map from a computed tomography (CT) image;

FIGS. 3 and 4 are views showing an example of a fat prediction model according to an embodiment;

FIG. 5 is a flowchart showing an example of a fat content measurement method according to an embodiment;

FIG. 6 is a view showing a configuration of an example of a fat content measurement apparatus according to an embodiment; and

FIG. 7 is a view showing an example of a converted image and a fat distribution image according to an embodiment.

### DETAILED DESCRIPTION

Reference will now be made in detail to embodiments, examples of which are illustrated in the accompanying drawings, wherein like reference numerals refer to like components throughout. In this regard, the present embodiments may have different forms and should not be construed as being limited to the descriptions set forth herein. Accordingly, the embodiments are merely described below, by referring to the figures, to explain aspects of the present description.

Hereinafter, a method and apparatus for measuring a fat content using a computed tomography (CT) image according to an embodiment will be described in detail with reference to the accompanying drawings.

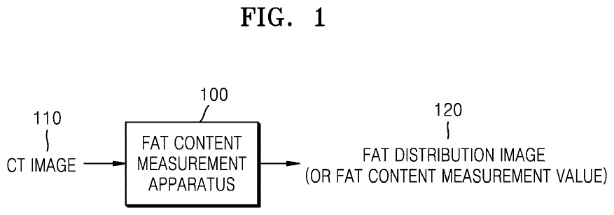

FIG. 1 is a view showing an example of a fat content measurement apparatus according to an embodiment.

Referring to FIG. 1, when a fat content measurement apparatus 100 receives a CT image 110, the fat content measurement apparatus 100 may generate and output a fat distribution image 120 or output a fat content measurement value. Alternatively, the fat content measurement apparatus 100 may output both the fat distribution image 120 and the fat content measurement value.

The fat distribution image 120 output by the fat content measurement apparatus 100 may be an image obtained by converting the CT image 110 into a proton distribution fat fraction (PDFF) map. The fat content measurement value output by the fat content measurement apparatus 100 may be a PDFF value.

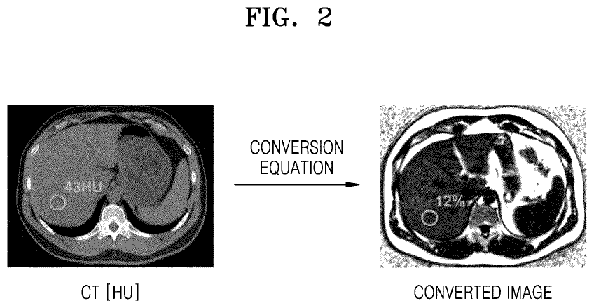

The PDFF map is an image in which a PDFF value is displayed by being mapped to each voxel, and an example thereof is shown in FIG. 2. The PDFF map is well known and thus will not be described in detail.

When the CT image is convertible into the PDFF map, the fat content may be quantified through the CT image. Thus, the current embodiment may propose a method of obtaining a PDFF map from a CT image. To distinguish an existing PDFF map obtained using a magnetic resonance image (MRI) from a PDFF map obtained from a CT image, the PDFF map generated from the CT image will be referred to as a ‘fat distribution image’.

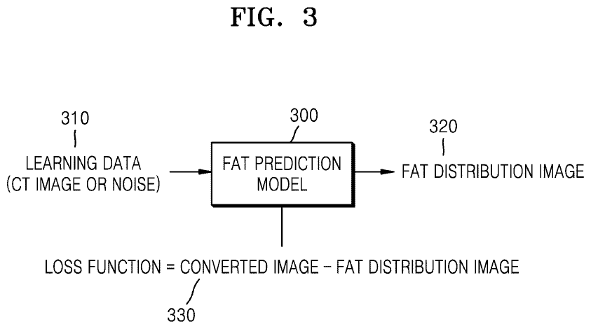

In an embodiment, a PDFF value of each voxel in the PDFF map obtained by the existing MRI may vary with a fat content and a brightness (e.g., a Hounsfield unit (HU) value) of each voxel may vary with a fat content in the CT image, such that the CT image may be converted into the PDFF map by using a relationship between a brightness of a CT voxel and a PDFF value of the PDFF map. An example thereof is shown in FIG. 2. However, when the PDFF map is obtained from the CT image by using a conversion equation as shown in FIG. 2, an accuracy thereof is degraded as will be described below, and thus, the current embodiment proposes a method of using an artificial intelligence (AI) model and an example thereof is shown in FIG. 3.

FIG. 2 is a view showing an example of a method of obtaining a PDFF map from a CT image.

Referring to FIG. 2, a PDFF map may be obtained from a CT image by using a conversion equation indicating a relationship between a brightness of a voxel of the CT image and a PDFF value of a voxel of the PDFF map.

In the PDFF map, a PDFF value expresses a fat content by %, and has a value between 0 and 100, but a range of a brightness (an HU value) of a voxel of the CT image is from −1000 (air) to several thousands or more. Thus, the range of the brightness of the CT image and the range of the PDFF value of the PDFF map do not 1:1 correspond to each other, and a relationship between the brightness and the PDFF value may not be linear in all sections. However, considering a range of HU values for fat, the relationship between the brightness of the voxel of the CT image and the PDFF value of the PDFF map may be expressed as a linear conversion equation, which may be expressed as an equation provided below.

$$𝒴 = - 0.58 * CT [ HU ] + 38.2 \qquad [ Equation 1 ]$$

where CT [HU] indicates a brightness (HU value) of a voxel of a CT image and y indicates a PDFF value. By using the foregoing conversion equation, a PDFF value for each voxel of the CT image may be obtained and may be expressed as a PDFF map.

The conversion equation may be merely an example for helping understanding, and the conversion equation indicating the relationship between the brightness of the voxel of the CT image and the PDFF value of the voxel of the PDFF map may be defined variously. However, for convenience of a description, the following description will be made assuming use of Equation 1 as the conversion equation.

As described above, the range of the brightness of the voxel of the CT image and the range of the PDFF value of the PDFF map are different from each other and a relationship therebetween is not necessarily linear, such that when the PDFF map is obtained merely using the conversion equation, the accuracy thereof may be low. Moreover, a PDFF value (y value) may be negative in the conversion equation when a brightness of a voxel is 66 HU or more in the CT image, and the PDFF value may be 100 or more when the brightness of the voxel is −120 HU or less.

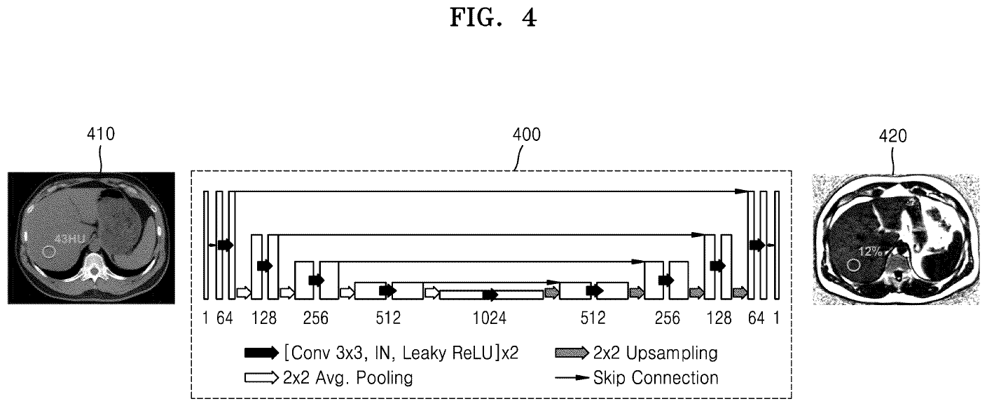

FIGS. 3 and 4 are views showing an example of a fat prediction model according to an embodiment.

Referring to FIGS. 3 and 4, a fat prediction model 300 may include an artificial neural network 400 that outputs a fat distribution image 420 including a PDFF map when receiving a CT image 410. The artificial neural network may be implemented in various conventional ways such as a convolutional neural network (CNN), etc., without being limited to a particular example. The artificial neural network is already known widely and thus will not be described further.

The fat prediction model 300 may be generated through learning. To train the fat prediction model 300, learning data 310 including a predefined CT image or noise image for learning may be used. The CT image for learning may be an image obtained by capturing a specific human body tissue such as a liver, etc., and the noise image may be literally an image including noise.

In an embodiment, the fat prediction model 300 may be trained using unsupervised learning without labeling. For unsupervised learning, the current embodiment may use a PDFF map generated from a CT image by using the foregoing conversion equation. Hereinbelow, the PDFF map generated using the conversion equation will be referred to as a ‘converted image’.

More specifically, the fat content measurement apparatus may generate a converted image by applying the conversion equation described with reference to FIG. 2 to a CT image (or noise image) for learning included in the learning data 310. The fat content measurement apparatus may obtain the fat distribution image 320 by inputting the CT image (or noise image) for learning to a fat prediction model 400. The fat content measurement apparatus may train the fat prediction model 300 such that a loss function 330 indicating an error between the converted image and the fat distribution image is minimum. That is, the fat prediction model 300 may perform a learning process of adjusting an internal parameter, etc., to minimize the loss function 330. The current embodiment may use the loss function 330 indicating an error between a converted image and a fat distribution image output by a fat prediction model, thereby applying unsupervised learning without labeling and using a noise image, instead of a CT image for learning, as learning data.

In another embodiment, the fat content measurement apparatus may train the fat prediction model by using a loss function indicating an error between a converted image from which a voxel out of a predefined range of PDFF values is removed and a fat distribution image from which the voxel out of the predefined range of PDFF values is removed. For example, as shown in FIG. 2, a PDFF value (y value) of a converted image may be negative when a brightness of a voxel of a CT image is 66 HU or more, and the PDFF value of the converted image may be 100 or more when the brightness of the voxel of the CT image is −120 HU or less, such that the fat content measurement apparatus may remove, from the converted image, a voxel with a PDFF value being less than 0 or exceeding 100 (for example, convert the PDFF value of the voxel into 0). The fat content measurement apparatus may also remove the voxel having the PDFF value being less than 0 or exceeding 100 from the fat distribution image. The fat content measurement apparatus may also train the fat prediction model by using the converted image and the fat distribution image each which include a PDFF value of 0 to 100, such that the loss function 330 is minimum.

In another embodiment, a loss function in which a sharpness variable is applied to the error between the converted image and the fat distribution image may be used. The loss function reflecting the sharpness variable may be expressed as below.

$$[ Equation 2 ]$$

$$Loss Function = {‖ Converted Image - Fat Distribution Image ‖}_{2}^{2} + {‖ Sharpness Variable ‖}_{1}$$

Herein, the sharpness variable may determine a sharpness of an image and may be preset. For example, the fat content measurement apparatus may predefine a sharpness variable or may receive a sharpness variable from a user in training of the fat prediction model 300. In Equation 2, the converted image and the fat distribution image each may include a PDFF value of 0 to 100. The sharpness variable may be omitted depending on an embodiment.

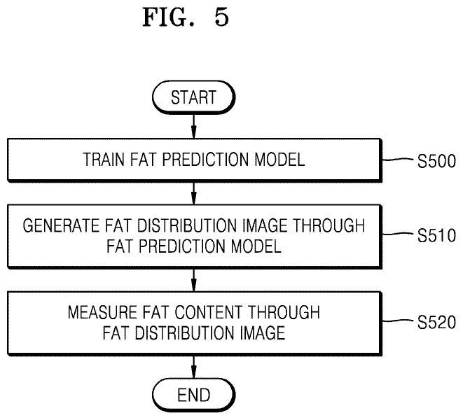

FIG. 5 is a flowchart showing an example of a fat content measurement method according to an embodiment.

Referring to FIG. 5, the fat content measurement apparatus may train a fat prediction model that generates a fat distribution image from a CT image, in operation S500. For example, the fat content measurement apparatus may train the fat prediction model such that a loss function indicating an error between a converted image, obtained by applying a predefined conversion equation to a CT image or noise image for learning, and a fat distribution image output by the fat prediction model is minimum.

For example, the converted image and the fat distribution image may be images from which voxels out of a range of predefined PDFF values are removed. In another embodiment, the loss function of the fat prediction model may be a function that applies a sharpness variable to the error between the converted image and the fat distribution image. An example of a method of training the fat prediction model is shown in FIG. 3.

The fat content measurement apparatus may generate the fat distribution image by the trained fat prediction model upon receiving a CT image for diagnosis, in operation S510. As the fat distribution image may be an image in which the PDFF value is mapped, the fat content measurement apparatus may accurately quantify a fat content of a target part from the fat distribution image, in operation S520.

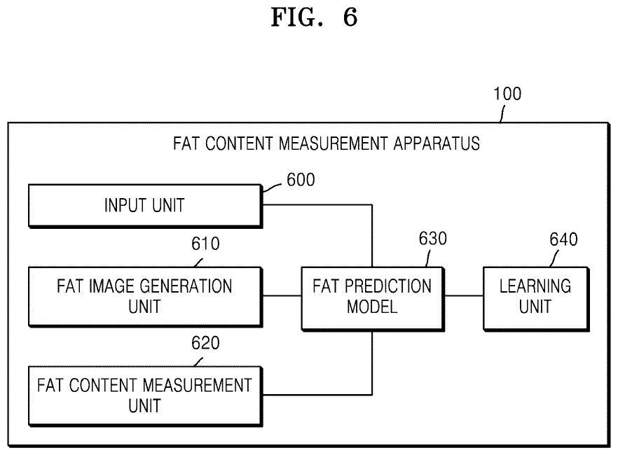

FIG. 6 is a view showing a configuration of an example of a fat content measurement apparatus according to an embodiment.

Referring to FIG. 6, the fat content measurement apparatus 100 may include an input unit 600, a fat image generation unit 610, a fat content measurement unit 620, a fat prediction model 630, and a learning unit 640. When the fat prediction model 630 having completed learning in various manners is used, the learning unit 640 may be omitted. For example, the fat content measurement apparatus 100 may be implemented as a computing device including a memory, a processor, and an input/output device. In this case, each of components 600 to 640 may be implemented with software and loaded on the memory, and then may be executed by the processor.

The input unit 600 may input the CT image for diagnosis to the fat prediction model 630 trained using learning data including a CT image or noise image for learning. The CT image for diagnosis may be a CT image of a patient requiring fat content measurement.

The fat image generation unit 610 may generate and output a fat distribution image for the CT image for diagnosis through the fat prediction model 630. The fat distribution image may include a PDFF map.

The fat content measurement unit 620 may measure fat content of a target part through the fat distribution image including the PDFF map.

The learning unit 640 may train the fat prediction model 630 by using learning data including a CT image or noise image for learning. For example, the learning unit 640 may train the fat prediction model 630 such that a loss function indicating an error between a converted image, obtained by applying a predefined conversion equation to a CT image, and a fat distribution image output by the fat prediction model is minimum. Herein, the loss function may be a function that obtains an error between a converted image from which a voxel out of a predefined range of PDFF values is removed and a fat distribution image from which the voxel out of the predefined range of PDFF values is removed. In another embodiment, the learning unit 640 may train the fat prediction model such that the loss function applying a predefined sharpness variable to the error between the converted image and the fat distribution image is minimum.

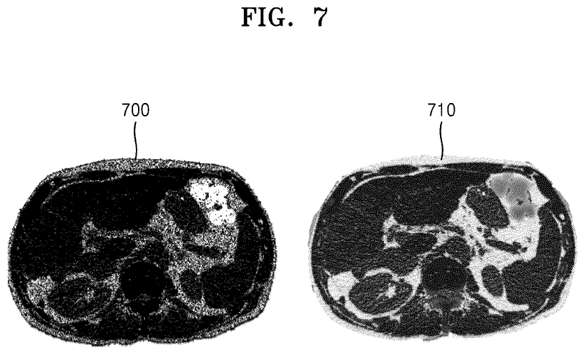

FIG. 7 is a view showing an example of a converted image and a fat distribution image according to an embodiment.

Referring to FIG. 7, a converted image 700 obtained by a conversion equation to a CT image obtained by capturing a liver and a fat distribution image 710 obtained using a fat prediction model according to the current embodiment are shown. The fat distribution image 710 obtained through the fat prediction model according to the current embodiment shows PDFF values that are clearer and more accurate for fat distribution than those of the converted image 700.

The disclosure may also be implemented as a computer-readable program code on a computer-readable recording medium. The computer-readable recording medium may include all types of recording devices in which data that is readable by a computer system is stored. Examples of the computer-readable recording medium may include read-only memory (ROM), random access memory (RAM), compact-disc ROM (CD-ROM), a magnetic tape, a floppy disk, an optical data storage device, etc. The computer-readable recording medium may be distributed over computer systems connected through a network to store and execute a computer-readable code in a distributed manner.

So far, embodiments have been described for the disclosure. It would be understood by those of ordinary skill in the art that the disclosure may be implemented in a modified form within a scope without departing from the essential characteristics of the disclosure. Therefore, the disclosed embodiments should be considered in a descriptive sense rather than a restrictive sense. The scope of the present specification is not described above, but in the claims, and all the differences in a range equivalent thereto should be interpreted as being included in the disclosure.

According to an embodiment of the present disclosure, by converting a CT image into an image of PDFF maps, an exact fat content of a body part may be measured. Fat content of a body part like a liver, etc., may be accurately quantified from a CT image captured without administration of a contrast medium.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A fat content measurement method performed by a fat content measurement apparatus, the fat content measurement method comprising:
receiving learning data comprising a computed tomography (CT) image or noise image for learning;
training, by using the learning data, a fat prediction model configured to generate a fat distribution image for a CT image; and
generating a fat distribution image to be used for fat content measurement by the fat prediction model having completed learning upon receiving a CT image for diagnosis,
wherein the training comprises training a fat prediction model such that a loss function indicating an error between a converted image, obtained by applying a predefined conversion equation to the CT image or noise image for learning, and the fat distribution image output by the fat prediction model is minimum.

2. The fat content measurement method of claim 1, wherein the converted image and the fat distribution image each comprise proton distribution fat fraction (PDFF) maps.

3. The fat content measurement method of claim 1, wherein the converted image and the fat distribution image are images from which a voxel out of a predefined range of PDFF values is removed.

4. The fat content measurement method of claim 1, wherein the training comprises training a fat prediction model such that a loss function applying a sharpness variable to the error is minimum.

5. A fat content measurement apparatus comprising:
an input unit configured to input a computed tomography (CT) image for diagnosis to a fat prediction model trained using learning data comprising a CT image or noise image for learning; and
a fat image generation unit configured to generate and output a fat distribution image for the CT image for diagnosis through the fat prediction model.

6. The fat content measurement apparatus of claim 5, further comprising a learning unit configured to train the fat prediction model by using the learning data,
wherein the learning unit is further configured to train the fat prediction model such that a loss function indicating an error between a converted image, obtained by applying a predefined conversion equation to a CT image, and the fat distribution image output by the fat prediction model is minimum.

7. The fat content measurement apparatus of claim 6, wherein the loss function is a function that obtains an error between a converted image from which a voxel out of a predefined range of PDFF values is removed and a fat distribution image from which the voxel out of the predefined range of PDFF values is removed.

8. The fat content measurement apparatus of claim 6, wherein the learning unit is further configured to train the fat prediction model such that a loss function applying a predefined sharpness variable to the error is minimum.

9. The fat content measurement apparatus of claim 5, further comprising a fat measurement unit configured to measure a fat content through a fat distribution image comprising proton distribution fat fraction (PDFF) maps.

10. A computer-readable recording medium having recorded thereon a computer program for executing the fat content measurement method according to claim 1.
